(19) United States
(12) Patent Application Publication
(10) Pub. No.: US 2005/0232655 A1
(43) Pub. Date: Oct. 20, 2005

(54) Image forming apparatus and image forming system

(75) Inventor: Yoshiura Syouichiro, Ikoma-gun (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 11/061,169

(22) Filed: Feb. 17, 2005

(30) Foreign Application Priority Data
Feb. 18, 2004 (JP) 2004-041911

(51) Int. Cl. B42D 15/10

(52) U.S. Cl. 399/130

(57) ABSTRACT

In an image forming apparatus having storing means for storing image data to be composited with received image data, means for compositing the image data with the received image data, means for forming an image based on the resulting composite image data, and determining means for determining whether or not image formation is possible, the image formation based on the image data is executed or stopped according to the determination result of the determining means.

### CROSS-REFERENCE TO RELATED APPLICATIONS

This non-provisional application claims priority under 35 U.S.C. §119(a) on Patent Application No. 2004-41911 filed in Japan on Feb. 18, 2004, the entire contents of which are hereby incorporated by reference.

### BACKGROUND OF THE INVENTION

1. Field of the Invention

The present invention relates to an image forming apparatus and an image forming system, capable of adding an image for restraining copying to printed material.

2. Description of Related Art

As one of techniques for preventing copying of printed material, a technique using a pantograph pattern in the background of a document which is prohibited from being copied has been known. A pantograph pattern consists of dots (foreground dots) in a size that remain even when a copy is made using a copying machine, and dots (background dots) which are so small and disappear when a copy is made. The background dots are provided around the foreground dots so that characters and patterns drawn by the foreground dots are not noticeable. When printed material on which a pantograph pattern is formed is copied, the background dots disappear and only the foreground dots remain, and consequently the characters and patterns drawn by the foreground dots appear. Therefore, by embedding characters such as “copy-prohibited” and “confidential document” drawn by the foreground dots in the pantograph pattern in advance, the printed material to be produced can have the effect of restricting copying by itself.

The technique of preventing copying using a pantograph pattern is mainly classified into two types. One is a technique using a special paper on which a pantograph pattern is printed in advance, and the other is a technique in which a pantograph pattern and a document are printed together as to be described later. With the former technique, by setting the special paper with a pantograph pattern on a paper feed tray of a printing apparatus and printing a document, printed material having the copy preventing effect is obtained. However, since it is necessary to prepare the paper on which a pantograph pattern is printed in advance, such a technique has the problem of an increase in the printing cost. Moreover, since predetermined characters and patterns for restricting copying are used, it is difficult to change the pantograph pattern according to a document, and thus this technique also has the problem of lack of convenience.

Therefore, in recent years, a technique was proposed to print a pantograph pattern on normal paper, etc. by providing a printer driver or a printing apparatus with the function of adding a pantograph pattern to an image of a document to be printed (see, for example, Japanese Patent Applications Laid Open No. 2001-324898 and No. 2003-224717). With a printer driver having the function of adding a pantograph pattern, by performing the process of compositing image data for a document and image data for a pantograph pattern together in an information processing apparatus in which the printer driver is installed and then transmitting to a printing apparatus a print job created based on the resulting composite image data, a document with the pantograph pattern in the background can be formed on normal paper. Similarly, in the case where a printing apparatus is provided with the function of adding a pantograph pattern, when addition of a pantograph pattern is instructed by a print job, it is possible to form a document with the pantograph pattern in the background on normal paper by compositing image data for the pantograph pattern with image data extracted from the print job and executing a print process based on the resulting composite image data. According to these techniques, by preparing a plurality of types of pantograph patterns in a printer driver or a printing apparatus, it is possible to select and use a pantograph pattern according to a document.

Since a pantograph pattern as described above is composed of a pattern of finely adjusted gradations, in order to print the pantograph pattern on normal paper, a printing apparatus must be able to faithfully reproduce the gradations. By the way, in a printing apparatus that forms an image by electrophotographic processes, when consumable supplies such as a photosensitive drum and developer deteriorate and need to be replaced, or when the printing apparatus is in a period of adjustment, the printing apparatus may fail to faithfully reproduce the gradations of the pantograph pattern. If it is impossible to faithfully reproduce the gradations of the pantograph pattern, an image intended to appear when a copy is made will not appear, and consequently there arises a problem that the effect of the pantograph pattern that restrains copying may not be sufficiently exhibited.

### BRIEF SUMMARY OF THE INVENTION

The present invention has been made with the aim of solving the above problems, and it is an object of the present invention to provide an image forming apparatus and an image forming system capable of executing processes after finding the current status of the image forming apparatus by making a determination, when forming an image by compositing received image data and image data stored in storing means, as to whether or not image formation based on the resulting composite image data is possible and executing or stopping the image formation according to the determination result so as to provide printed material in a condition capable of exhibiting the effect of a pantograph pattern.

An image forming apparatus according to the present invention is an image forming apparatus that receives image data and forms an image on a sheet based on the received image data, and characterized by comprising: storing means for storing image data to be composited with the received image data; means for compositing the image data with the received image data; means for forming an image based on the resulting composite image data; and determining means for determining whether or not image formation by the means is possible, wherein the image formation based on the image data is executed or stopped according to a determination result of the determining means.

In the present invention, when forming an image by compositing received image data and image data stored in the storing means together, a determination is made as to whether or not image formation based on the resulting composite image data is possible, and then the image formation is executed or stopped according to the determination result. Therefore, when the determining means determines that it is impossible to form the resulting composite image due to deterioration of various parts and consumable supplies in the means for forming an image, it is possible to control the apparatus to stop the image formation. As a result, the quality of the image to be outputted can be maintained at a fixed level, and, for example, an image such as a pantograph pattern that requires fine gradation representation can be provided as printed material only when it is possible to faithfully reproduce the gradation representation.

The image forming apparatus according to the present invention is characterized by comprising detecting means for detecting the quality of an image to be formed on a sheet, wherein the determining means determines, based on a detection result of the detecting means, whether or not image formation is possible.

In the present invention, the quality of an image to be formed on a sheet is detected, and a determination as to whether image formation is possible or not is made based on the detection result. Therefore, when the determining means determines that it is impossible to form the composite image at a fixed level of quality due to deterioration of various parts, consumable supplies, etc., it is possible to control the apparatus to stop the image formation, and consequently the quality of the image to be outputted can be maintained at a fixed level.

The image forming apparatus according to the present invention is characterized by comprising measuring means for measuring the density of an image, wherein the detecting means detects the quality of the image based on the density measured by the measuring means.

In the present invention, the image quality is detected based on the result of measuring the density of the image. Therefore, for example, when it is impossible to faithfully reproduce the gradations of a pantograph pattern, it is possible to control the apparatus to stop the image formation.

The image forming apparatus according to the present invention is characterized by comprising predicting means for predicting the quality of an image to be formed on a sheet, wherein the determining means determines, based on a prediction result of the predicting means, whether or not image formation is possible.

In the present invention, the quality of an image to be formed on a sheet is predicted, and a determination as to whether image formation is possible or not is made based on the prediction result. Therefore, when it is possible to predict that it is impossible to form the composite image at a fixed level of quality due to deterioration of various parts, consumable supplies, etc., it is possible to control the apparatus to stop the image formation, and consequently the quality of the image to be outputted can be maintained at a fixed level.

The image forming apparatus according to the present invention is characterized by comprising means for detecting the remaining amount of a consumable member used for image formation, wherein the predicting means predicts the quality of the image based on the detection result of the means.

In the present invention, the remaining amount of a consumable member used for image formation is detected, and the quality of the image is predicted based on the detection result. Therefore, when it is possible to predict that it is impossible to form the composite image at a fixed level of quality due to deterioration of the consumable member, etc., it is possible to control the apparatus to stop the image formation, and consequently the quality of the image to be outputted is maintained at a fixed level.

The image forming apparatus according to the present invention is characterized by comprising means for counting the number of times image formation was executed, wherein the predicting means predicts the quality of the image based on the number counted by the means.

In the present invention, the number of times image formation was executed is counted, and the quality of the image is predicted based on the counted number. Therefore, when it is possible to predict degradation of image quality due to repetitions of image formation, it is possible to control the apparatus to stop the image formation, and consequently the quality of the image to be outputted can be maintained at a fixed level.

The image forming apparatus according to the present invention is characterized by further comprising means for compensating for degradation of the image quality when the detection result or the prediction result shows degradation of the image quality.

In the present invention, when the result of detecting the quality of an image, or the result of predicting the quality of an image shows degradation of the image quality, the degradation of the image quality is compensated. Therefore, the quality of the image to be outputted can be maintained at a fixed level, and, when it is impossible to compensate for the degradation of the image quality, the image formation can be stopped.

The image forming apparatus according to the present invention is characterized by forming an image on a sheet by electrophotographic processes.

In the present invention, since image formation is performed by electrophotographic processes, a determination as to whether or not it is possible to faithfully reproduce an image such as a pantograph pattern can be made after finding the condition of a photosensitive drum, developer, etc., and thus it is possible to provide printed material only when a faithful reproduction is possible.

The image forming apparatus according to the present invention is characterized by further comprising means for giving information stating a determination result when the determining means determines that image formation based on the composite image data is impossible.

In the present invention, when the determining means determines that image formation based on the composite image data is impossible, the information stating a determination result of the determining means is given, thereby warning the user that an image such as a pantograph pattern may not be added appropriately due to deterioration of the electrophotographic processes, etc.

The image forming apparatus according to the present invention is characterized in that the image data stored in the storing means is image data for forming a pantograph pattern.

In the present invention, since a pantograph pattern is stored as an image for composition, it is possible to provide printed material to which a pantograph pattern with faithfully reproduced gradation representation has been added.

An image forming system according to the present invention is an image forming system including an image transmitting apparatus having means for transmitting image data, and an image forming apparatus for receiving image data transmitted from the image transmitting apparatus and forming an image on a sheet based on the received image data, and characterized in that the image forming apparatus comprises storing means for storing image data to be composited with the received image data; means for compositing the image data with the received image data; means for forming an image based on the resulting composite image data; determining means for determining whether or not image formation by the means is possible; and means for transmitting information regarding a determination result to the image transmitting apparatus, and the image transmitting apparatus comprises means for receiving the information transmitted from the image forming apparatus; and means for controlling, based on the received information, whether or not to transmit the image data.

In the present invention, a determination as to whether or not to transmit the image data is made based on the information indicating whether or not image formation is possible. Therefore, when the image forming apparatus determines that it is impossible to form the resulting composite image due to deterioration of various parts and consumable supplies in the means for forming an image, it is possible to control the apparatus to stop the transmission of image data. As a result, the quality of the image to be outputted can be maintained at a fixed level, and, for example, an image such as a pantograph pattern that requires fine gradation representation can be provided as printed material only when it is possible to faithfully reproduce the gradation representation.

The image forming system according to the present invention is characterized in that the image transmitting apparatus further comprises means for giving information stating that transmission of image data is stopped when the transmission of image data is stopped.

In the present invention, when stopping the transmission of image data, since the information stating that the transmission of image data is stopped is given, it is possible to warn a user that an image such as a pantograph pattern may not be added appropriately due to deterioration of the electrophotographic processes, etc.

The image forming system according to the present invention is characterized in that the image forming system comprises a plurality of the image forming apparatuses, and the image transmitting apparatus has means for selecting a destination to send image data, based on information transmitted from each image forming apparatus.

In the present invention, since a destination to send image data is selected based on information transmitted from each image forming apparatus, it is possible, for example, to a select an image forming apparatus capable of faithfully reproducing a pantograph pattern and cause it to perform the processes.

According to the present invention, when forming an image by compositing received image data and image data stored in the storing means, a determination is made as to whether or not image formation based on the resulting composite image data is possible, and the image formation is executed or stopped according to the determination result. Therefore, when the image forming apparatus determines that it is impossible to form the resulting composite image due to deterioration of various parts and consumable supplies in the means for forming an image, it is possible to control the apparatus to stop the image formation. As a result, the quality of the image to be outputted can be maintained at a fixed level, and, for example, an image such as a pantograph pattern that requires fine gradation representation can be provided as printed material only when it is possible to faithfully reproduce the gradation representation.

According to the present invention, the quality of an image to be formed on a sheet is detected, and a determination as to whether image formation is possible or not is made based on the detection result. Therefore, when the image forming apparatus is determined to be unable to form the composite image at a fixed level of quality due to deterioration of various parts, consumable supplies, etc., it is possible to control the apparatus to stop the image formation, and consequently the quality of the image to be outputted can be maintained at a fixed level.

According to the present invention, the quality of an image is detected based on the result of measuring the density of the image. Therefore, for example, if it is impossible to faithfully reproduce the gradations of a pantograph pattern, then it is possible to stop the image formation.

According to the present invention, the quality of an image to be formed on a sheet is predicted, and a determination as to whether image formation is possible or not is made based on the prediction result. Therefore, when it is possible to predict that it is impossible to form the composite image at a fixed level of quality due to deterioration of various parts, consumable supplies, etc., it is possible to control the apparatus to stop the image formation, and consequently the quality of the image to be outputted can be maintained at a fixed level.

According to the present invention, the remaining amount of a consumable member used for image formation is detected, and the quality of the image is predicted based on the detection result. Therefore, when it is possible to predict that it is impossible to form the composite image at a fixed level of quality due to deterioration of the consumable member, etc., it is possible to control the apparatus to stop the image formation, and consequently the quality of the image to be outputted can be maintained at a fixed level.

According to the present invention, the number of times image formation was executed is counted, and the quality of the image is predicted based on the counted number. Therefore, when degradation of image quality is predicted from repetitions of image formation, it is possible to control the apparatus to stop the image formation, and consequently the quality of the image to be outputted can be maintained at a fixed level.

According to the present invention, when the result of detecting the quality of an image, or the result of predicting the quality of an image shows degradation of the image quality, the degradation of the image quality is compensated. Therefore, the quality of the image to be outputted can be maintained at a fixed level, and, if it is impossible to compensate for the degradation of the image quality, the image formation can be stopped.

According to the present invention, since image formation is performed by electrophotographic processes, a determination as to whether or not it is possible to faithfully reproduce an image such as a pantograph pattern can be made after finding the condition of a photosensitive drum, developer, etc., and thus it is possible to provide printed material only when a faithful reproduction is possible.

According to the present invention, if image formation based on the composite image is determined to be impossible, the information stating a determined result is given, and thus it is possible to warn a user that an image such as a pantograph pattern may not be added appropriately due to deterioration of the electrophotographic processes, etc.

According to the present invention, since a pantograph pattern is stored as an image for composition, it is possible to provide printed material to which a pantograph pattern with faithfully reproduced gradation representation has been added.

According to the present invention, a determination as to whether or not to transmit image data is made based on the information indicating whether or not image formation is possible. Therefore, when the image forming apparatus determines that it is impossible to form the resulting composite image due to deterioration of various parts and consumable supplies in the means for forming an image, it is possible to control the apparatus to stop the transmission of image data. As a result, the quality of the image to be outputted can be maintained at a fixed level, and, for example, an image such as a pantograph pattern that requires fine gradation representation can be provided as printed material only when it is possible to faithfully reproduce the gradation representation.

According to the present invention, when stopping the transmission of image data, since the information stating that the transmission of image data is stopped is given, it is possible to warn a user that an image such as a pantograph pattern may not be added appropriately due to deterioration of the electrophotographic processes, etc.

According to the present invention, since a destination to send image data can be selected based on information transmitted from each image forming apparatus, it is possible, for example, to select an image forming apparatus capable of faithfully reproducing a pantograph pattern and cause it to perform the processes.

The above and further object and features of the invention will more fully be apparent from the following detailed description with accompanying drawings.

### BRIEF DESCRIPTION OF THE SEVERAL VIEWS OF THE DRAWINGS

FIG. 1 is a schematic view showing the entire structure of an image forming system according to an embodiment;

FIG. 2 is a block diagram for explaining the internal structure of a printing apparatus;

FIG. 3 is a schematic cross sectional view for explaining the detail of an image forming section;

FIG. 4 is a flowchart for explaining the processing steps to be executed when a printing apparatus receives a print job;

FIG. 5 is a schematic view showing one example of a message screen displayed on an information processing apparatus if a reproduction of an additional image is impossible;

FIG. 6 is a schematic view showing the entire structure of an image forming system according to an embodiment;

FIG. 7 is a block diagram for explaining the internal structure of a print server;

FIG. 8 is a concept view showing one example of an apparatus information management table;

FIG. 9 is a flowchart for explaining the processing steps to be executed when the print server receives a print job; and

FIG. 10 is a schematic view showing one example of a message screen to be displayed on an information processing apparatus if a reproduction of an additional image is impossible.

### DETAILED DESCRIPTION OF THE INVENTION

The following description will specifically explain the present invention, based on the drawings illustrating some embodiments thereof.

### Embodiment 1

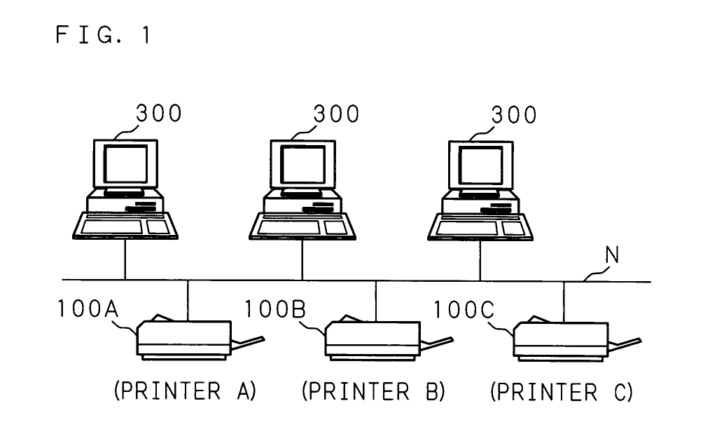

FIG. 1 is a schematic view showing the entire structure of an image forming system according to this embodiment. In FIG. 1, 100A, 100B and 100C represent printing apparatuses for forming an image on a sheet of paper, OHP film, etc., and information processing apparatuses 300, 300, 300 such as personal computers and workstations are connected to these printing apparatuses 100A, 100B and 100C through communication network N. In the information processing apparatus 300, application programs for creating documents, graphics, etc. and a driver program (printer driver) for using the printing apparatus 100A, 100B or 100C through the communication network N are installed in advance, and the information processing apparatus 300 can output prints of created documents, graphics, etc. by calling the printer driver from an arbitrary application program and transmitting print jobs created by the printer driver to a target printing apparatus 100A (or printing apparatus 100B or 100C).

It should be noted that the printing apparatuses 100A, 100B and 100C will be hereinafter collectively referred to as the printing apparatuses 100 if it is not necessary to particularly distinguish them from each other.

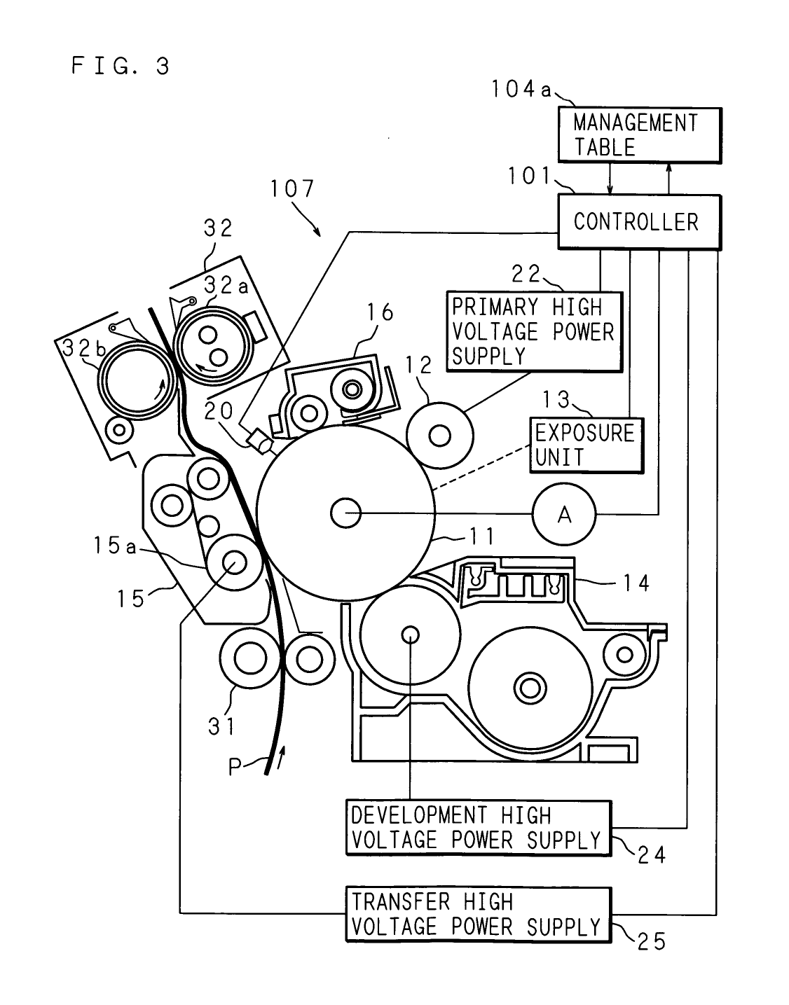

In this embodiment, when the printing apparatus 100 receives a print job giving an instruction to add a pantograph pattern, it confirms the condition of an image forming section 107 (see FIG. 3) comprising a electrostatic charger, an exposure unit and a developing unit, and then determines whether or not it is possible to reproduce an image in a condition capable of exhibiting the effect of a pantograph pattern. Further, even when the electrostatic charger, exposure unit, developing unit, etc. were adjusted, if the image forming section 107 is not capable of compensating for a pantograph pattern, the printing apparatus 100 stops the print process and asks whether the user wants to continue the print process.

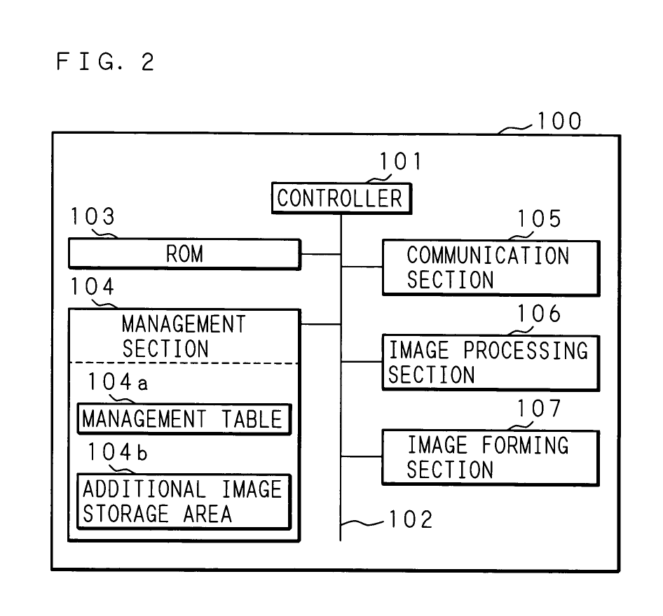

FIG. 2 is a block diagram for explaining the internal structure of a printing apparatus 100. The printing apparatus 100 comprises a controller 101. When the controller 101 reads and executes a control program pre-stored in a ROM 103, it controls various hardware devices connected through a bus 102 and causes them to operate as an apparatus for executing the above-mentioned processes as a whole. A management section 104 is composed of a semiconductor memory, and a part of its storage area is used as a management table 104a for managing the condition of the respective hardware devices, and an additional image storage area 104b for storing a pantograph pattern as image data. The controller 101 of the printing apparatus 100 obtains the information about the installed hardware by communicating with the respective hardware devices when power is supplied, and always confirms the hardware devices being in operation and updates the contents of the management table 104a if there is a change in the operation status.

A communication section (a receiving section, a transmitting section) 105 has a communication interface according to the communication standards of communication network N, receives print jobs from the information processing apparatuses 300, 300, 300 connected to the communication network N, and transmits information to be given to the information processing apparatuses 300, 300, 300. Further, the communication section 105 has a storage area for holding the information about the printing apparatus 100, and manages the apparatus information such as the operation status, paper information, and the remaining toner amount in the form of a database called MIB (Management Information Base). Software (for example, SNMP manager, SNMP: Simple Network Management Protocol) for monitoring the apparatus information is installed in the information processing apparatus 300. Upon a request from this software, the communication section 105 extracts necessary information from the MIB, and transmits the information to the information processing apparatus 300 which made the request. The communication section 105 controls the transmission and reception of the various types of information.

An image processing section 106 comprises an image memory for temporarily holding image data extracted from a print job received by the communication section 105, an IC (Integrated Circuit) for image processing and a DSP (Digital Signal Processor) to perform image processing on the image data held in the image memory. Image processing to be performed on the image data by the image processing section 106 includes an enlargement/reduction process, gradation adjustment process, pantograph pattern compositing process, etc. specified by print jobs.

The image forming section 107 comprises a electrostatic charger for charging a photosensitive drum to a predetermined electric potential; an exposure unit for creating an electrostatic latent image on the photosensitive drum by emitting laser light according to image data received from an external device; a developing unit for visualizing the image by supplying toner to the electrostatic latent image formed on the photosensitive drum surface; and a transfer unit 15 (see FIG. 3) for transferring the toner image formed on the photosensitive drum surface to a sheet of paper, OHP film, or the like. The image forming section 107 forms an image desired by the user on paper by using an electrophotographic technique.

FIG. 3 is a schematic cross sectional view for explaining the detail of the image forming section 107. This printing apparatus 100 comprises the image forming section 107 in which a electrostatic charger 12, an exposure unit 13, a developing unit 14, a transfer unit 15 and a cleaning unit 16 are disposed around a photosensitive drum 11. As the electrostatic charger 12, a roller type electrostatic charger designed to come into contact with the photosensitive drum 11 is used, and the electrostatic charger 12 charges the surface of the photosensitive drum 11 uniformly to a predetermined electric potential by a voltage applied from a primary high voltage power supply 22. Note that it may also be possible to use a brush type electrostatic charger or a charger type electrostatic charger instead of the roller type electrostatic charger. The exposure unit 13 is composed of a laser scanning unit (LSU) comprising a laser illuminating section, and a reflection mirror and a polygon mirror (not shown) are disposed so that the laser light emitted from the laser illuminating section strikes on the photosensitive drum 11. Note that it may also be possible to use a write head composed of light emitting elements, such as EL (Electro luminescence) and LED (Light Emitting Diode), arranged in an array instead of the laser illuminating section. The developing unit 14 stores a black toner, and supplies the toner to the electrostatic latent image formed on the surface of the photosensitive drum 11 so as to visualize the image. In this case, a high voltage (developing bias) is applied to the toner by a development high voltage power supply 24, and the electrostatic latent image is formed on the photosensitive drum 11 by supplying the toner charged to a predetermined polarity.

The electrostatic latent image formed on the photosensitive drum 11 is transferred onto paper P by the transfer unit 15. The transfer unit 15 has a transfer roller 15a disposed to face the photosensitive drum 11 in a region where it comes into contact with the paper P, and transfers the electrostatic latent image on the photosensitive drum 11 to the paper P by applying a high voltage (transfer bias) of the opposite polarity to the polarity of the charged toner to the transfer roller 15a by a transfer high voltage power supply 25. Note that the paper P is separated and fed one sheet at a time from a paper feed cassette (not shown), and then temporarily held by resist rollers 31 located under the transfer unit 15. The resist rollers 31 transport the paper P to a transfer region formed by the photosensitive drum 11 and the transfer roller 15a in a timing so that the top end of the electrostatic latent image on the photosensitive drum 11 is aligned with the top end of the image formation region of the paper P.

The paper P with the transferred toner image is transported substantially perpendicularly and reaches a fixing unit 32. The fixing unit 32 comprises a heat roller 32a and a pressure roller 32b, and fixes the toner image onto the paper P by applying heat of the heat roller 32a to the paper P nipped between the two rollers 32a and 32b. The paper P to which the toner image is fixed is discharged to a discharge tray (not shown).

Moreover, in order to always keep the density of an image to be formed on the paper P at a uniform level in a stable manner, the adhesion amount of toner to be transferred to the surface of the photosensitive drum 11 needs to be kept uniform. In this embodiment, therefore, a photo sensor 20 is provided in the front stage of the cleaning unit 16 to detect the adhesion amount of toner on the photosensitive drum 11 and control the adhesion amount of toner based on the detection result. The photo sensor 20 comprises a light emitting diode for emitting light onto the photosensitive drum 11, and a photodiode for receiving reflected light of the light emitted by the light emitting diode (not shown).

When detecting the adhesion amount of toner, the exposure unit 13 performs an exposure process based on a patch image prepared for detection and the developing unit 14 executes a development process to form a toner image of the patch image for detection on the surface of the photosensitive drum 11. Then, the photo sensor 20 detects the density of the patch image for detection, and transmits the detection result to the controller 101. The controller 101 which received the detection result performs an arithmetic operation to calculate a toner adhesion amount on the photosensitive drum 11. If the calculated toner adhesion amount does not fall within a predetermined range, the controller 101 optimizes the control values concerning the image density. Here, the control values concerning the image density are the charging voltage of the photosensitive drum 11 by the primary high voltage power supply 22, the exposure value of the exposure unit 13, and the developing bias applied by the development high voltage power supply 24. The image density is adjusted by changing at least one of these control values. The values such as the output value of the photo sensor 20, the charging voltage of the photosensitive drum 11, the exposure value of the exposure unit 13 and the developing bias are recorded in the management table 104a and managed. Note that such an adjustment of the image density is made automatically or according to an instruction of the user, for example, when power is supplied to the printing apparatus 100 or when the printing apparatus 100 is waiting for a print job.

In this embodiment, recommended ranges are set for both of an image density range capable of stably forming an image received as a print job and an image density range capable of faithfully reproducing the gradations of a pantograph pattern. Even when the above-mentioned control values were changed, if the image density falls outside the recommended ranges, a message stating that consumable supplies such as the photosensitive drum 11 and toner need to be replaced, or a message stating that the pantograph pattern can not be added appropriately, is given to the user.

In this embodiment, although the printing apparatus 100 is explained as an image forming apparatus for forming a monochrome image, it is of course possible that the printing apparatus 100 may be an image forming apparatus which comprises a photosensitive drum 11, a electrostatic charger 12, an exposure unit 13, a developing unit 14, etc. for each of yellow, magenta, cyan and black colors, and forms a full-color image by transferring the toner images in the respective colors in a superimposed manner.

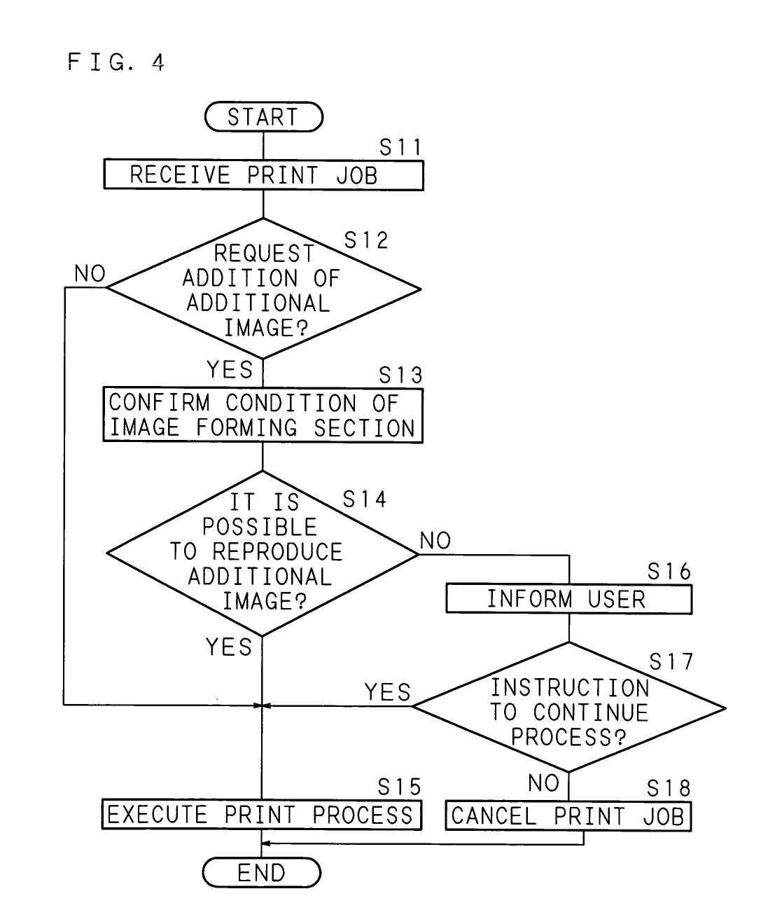

FIG. 4 is a flowchart for explaining the processing steps to be executed when the printing apparatus 100 receives a print job. The controller 101 of the printing apparatus 100 always monitors the state of the communication section 105 so as to determine whether or not a print job has been received. As a result, when the controller 101 determines that a print job from an information processing apparatus 300 has been received (step S11), it extracts print data from the print job. The print data contains the instruction content set by the printer driver in the information processing apparatus 300, and image data for printing. Then, the controller 101 of the printing apparatus 100 refers to the instruction content set by the printer driver, and determines whether or not addition of an additional image (pantograph pattern) is requested (step S12). If the controller 101 determines that the print job does not request addition of an additional image (S12: NO), then the controller 101 executes a print process based on the image data extracted from the print job (step S15). On the other hand, if the controller 101 determines that the print job requests addition of an additional image (S12: YES), then it refers to the corresponding items registered in the management table 104a and confirms the condition of the image forming section 107 (step S13).

As a result of confirming the condition of the image forming section 107, the controller 101 determines whether or not it is possible to reproduce the additional image, that is, whether or not the degradation of the pantograph pattern is in a range capable of being compensated by controlling the charging voltage of the photosensitive drum 11, the amount of laser light emitted onto the photosensitive drum 11 by the exposure unit 13, the developing bias applied to the developing unit 14 by the development high voltage power supply 24, etc. (step S14). If the controller 101 determines that it is possible to reproduce the additional image (S14: YES), then it reads the image data for the pantograph pattern stored in the additional image storage area 104a of the management section 104, and executes a print process after performing the process of compositing the read image data and the image data extracted from the print job in the image processing section 106 (S15).

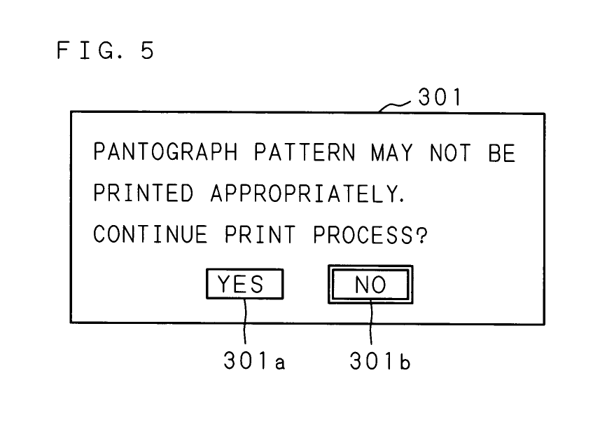

In step S14, if the controller 101 determines that it is impossible to reproduce the additional image (S14: NO), that is, if there is a possibility that the additional image may be printed in a condition incapable of exhibiting the effect of the pantograph pattern, then the controller 101 informs the user of this fact (step S16). More specifically, the controller 101 informs the user of this fact by writing information stating that it is impossible to reproduce the additional image as the status of the apparatus into the above-mentioned MIB, and causing the SNMP manager of the information processing apparatus 300 to create and display a message screen on the display section (not shown) of the information processing apparatus 300 when the information is obtained. FIG. 5 is a schematic view showing one example of a message screen to be displayed on the information processing apparatus 300 if a reproduction of an additional image is impossible. On a message screen 301 shown in FIG. 5, a message stating that there is a possibility that the pantograph pattern may not be printed appropriately is displayed, and select buttons 301a and 301b for asking whether the user wants to continue the print process are provided. When the select button 301a is pressed, the print process continues, whereas when the select button 301b is pressed, the print process is cancelled. The result of a selection made on this message screen 301 is given to the printing apparatus 100.

The controller 101 of the printing apparatus 100 determines, based on the selection result given from the information processing apparatus 300, whether or not an instruction to continue the print process is given (step S17). If the controller 101 determines that an instruction to continue the print process is given (S17: YES), then it executes the print process after compositing the image data extracted from the print job and the image data for the pantograph pattern (S15). On the other hand, if the controller 101 determines that an instruction to continue the print process is not given (S17: NO), then it cancels the print job (step S18), and finishes the processing of this flowchart.

In this embodiment, the controller 101 confirms the condition of the image forming section 107 and determines whether or not it is possible to reproduce a pantograph pattern. However, it may also be possible to design the controller 101 so that the controller 101 counts the number of times the print process was executed after replacement of a consumable supply such as toner, and when the counted number exceeds a predetermined number, the controller 101 makes a determination that a faithful reproduction of a pantograph pattern is impossible and informs the user of this fact.

### Embodiment 2

In Embodiment 1, the printing apparatus 100 which received a print job confirms the condition of the image forming section 107 and determines whether or not it is possible to reproduce a pantograph pattern, and then gives information based on the determination result to the information processing apparatus 300 which sent this print job. However, if a network is constructed to send a print job through a print server, it may also be possible to manage the apparatus information about the respective printing apparatuses 100A, 100B and 100C by the print server, and determine the reproducibility of a pantograph pattern when the print server receives a print job.

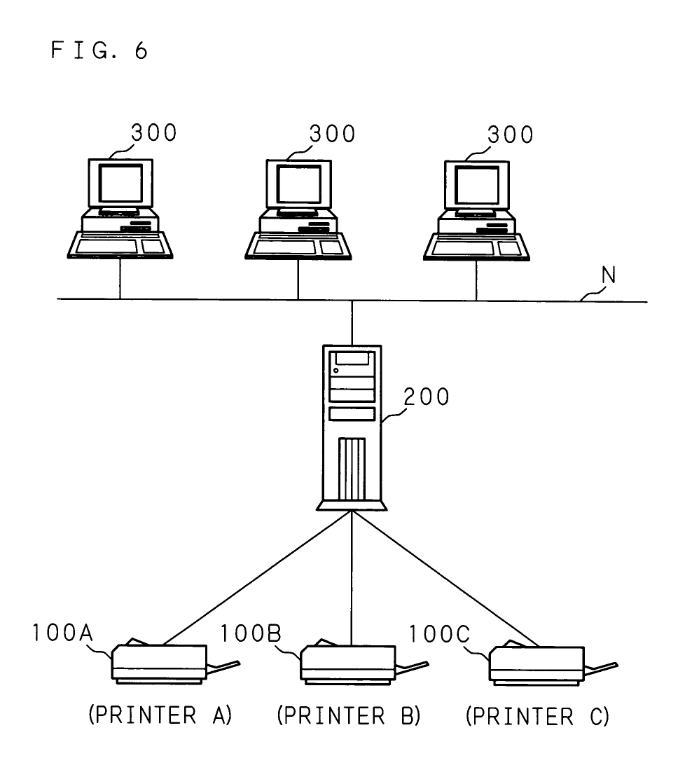

FIG. 6 is a schematic view showing the entire structure of an image forming system according to this embodiment. A print server 200 is connected to information processing apparatuses 300, 300, 300 such as personal computers and workstations through communication network N, and a plurality of printing apparatuses 100A, 100B and 100C are connected to the print server 200. The information processing apparatus 300 can cause any printing apparatuses 100A, 100B and 100C to execute outputting of prints via the print server 200.

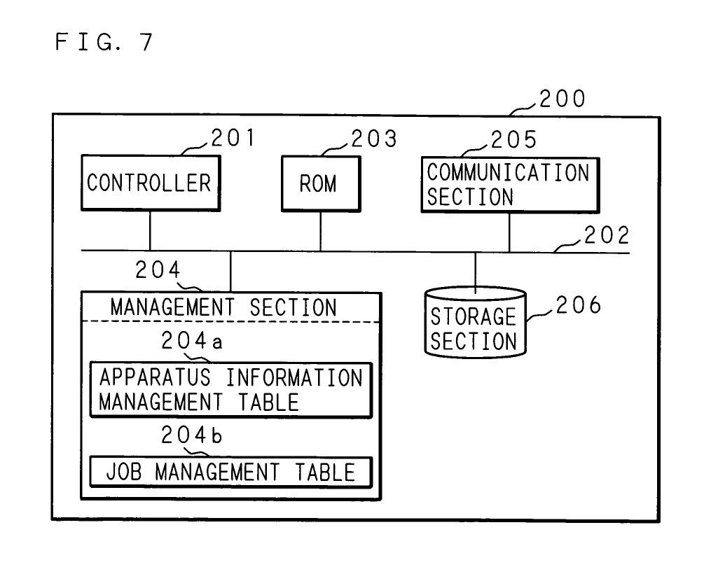

FIG. 7 is a block diagram for explaining the internal structure of a print server 200. The print server 200 comprises a controller 201. When the controller 201 reads and executes a control program pre-stored in a ROM 203, it controls various hardware devices connected through a bus 202. A management section 204 is composed of a semiconductor memory, and a part of its storage area are used as an apparatus information management table 204a for managing the operation status of the connected printing apparatuses 100A, 100B and 100C, and a job management table 204b for managing the information about print jobs received from the information processing apparatuses 300. A communication section (a receiving section, a transmitting section) 205 has a communication interface according to the communication standards of communication network N, receives print jobs from the information processing apparatuses 300 connected to the communication network N, and transmits information to be given to the information processing apparatuses 300. Moreover, software such as the SNMP manager for obtaining the apparatus information about the respective printing apparatuses 100A, 100B and 100C is installed in the print server 200, and the print server 200 periodically outputs to the respective printing apparatuses 100A, 100B and 100C a request to transmit the apparatus information through the communication section 205, and receives the apparatus information transmitted from the respective printing apparatuses 100A, 100B and 100C. The received apparatus information is managed in the apparatus information management table 204a of the management section 204. A storage section 206 is a semiconductor memory or a HDD device, and stores print jobs received through the communication section 205. Further, the storage section 206 transmits a print job to a target printing apparatus 100A (or printing apparatus 100C or 100C) in a timing instructed by the controller 201.

Note that since the internal structures of the printing apparatuses 100A, 100B and 100C are the same as that of the printing apparatus 100 explained in Embodiment 1, the explanation thereof is omitted.

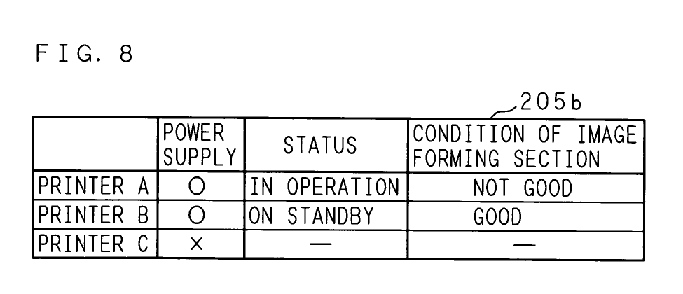

FIG. 8 is a concept view showing one example of the apparatus information management table 204a. In the apparatus information management table 204a shown in FIG. 8, the ON/OFF state of power supply, the operation status, and the condition of the image forming section 107 are stored in association with each other for each of the printing apparatuses 100A, 100B and 100C. The ON/OFF state of power supply is indicated by “o” or “x”, “o” showing that the power supply is ON, and “x” showing that the power supply is OFF. As the operation status, whether the apparatus is “in operation” or “on standby” is shown. As the condition of the image forming section 107, information indicating whether or not the image forming section 107 is in a condition capable of satisfactorily adding a pantograph pattern is registered. These pieces of information can be obtained by periodically requesting the printing apparatuses 100A, 100B and 100C to transmit the apparatus information, and the apparatus information management table 204a is updated based on the obtained information as occasion arises.

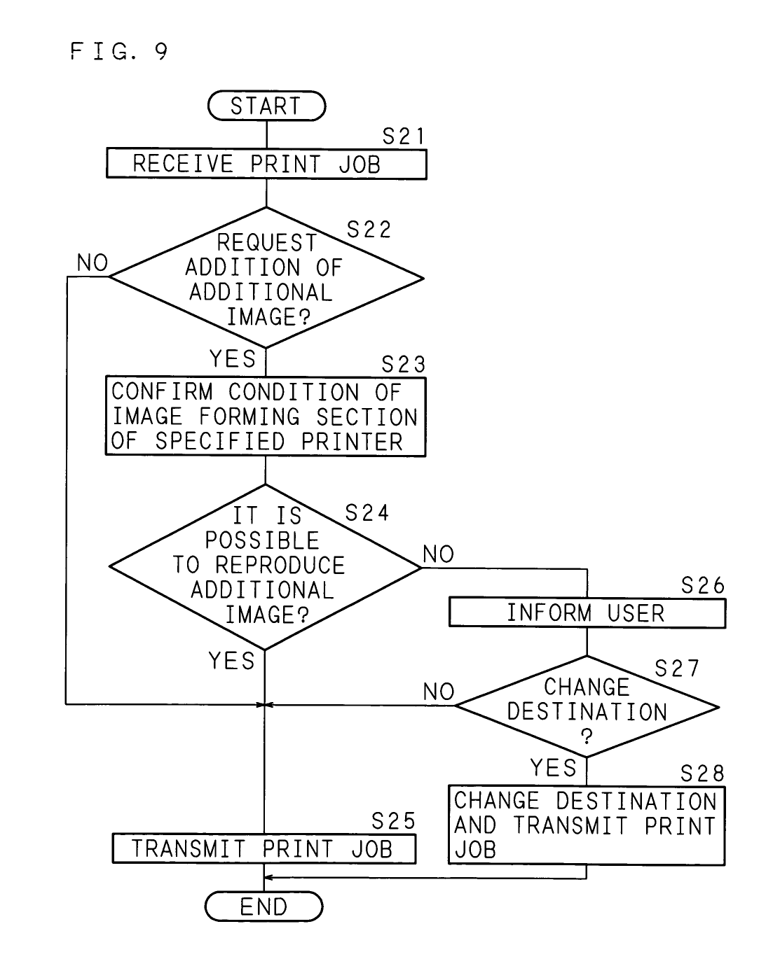

FIG. 9 is a flowchart for explaining the processing steps to be executed when the print server 200 receives a print job. The controller 201 of the print server 200 always monitors the state of the communication section 205 so as to determine whether or not a print job has been received. As a result, when the controller 201 determines that a print job from an information processing apparatus 300 has been received (step S21), it extracts print data from the print job. The print data contains the instruction content set by the printer driver, and image data for printing. Then, the controller 201 of the print server 200 refers to the instruction content set by the printer driver, and determines whether or not the addition of an additional image (pantograph pattern) is requested (step S22). If the controller 201 determines that the print job does not request the addition of an additional image (S22: NO), then the controller 201 transmits the print job to a target printing apparatus 100A (or printing apparatus 100B or 100C) (step S25). On the other hand, if the controller 201 determines that the print job requests the addition of an additional image (S22: YES), then it refers to the apparatus information management table 204a in the management section 204 and confirms the condition of the image forming section 107 of the specified printing apparatus 100A (or printing apparatus 100B or 100C) (step S23).

As a result of confirming the condition of the image forming section 107 of the specified printing apparatus, the controller 201 determines whether or not it is possible to reproduce the additional image (step S24). If the controller 201 determines that it is possible to reproduce the additional image (S24: YES), then it transmits the print job to the specified printing apparatus 100A (or printing apparatus 100B or 100C) (S25). The transmitted print job is processed by the printing apparatus 100A (or printing apparatus 100B or 100C) to which the print job was sent, and the print process is performed after compositing the image data for printing and the image data for the pantograph pattern.

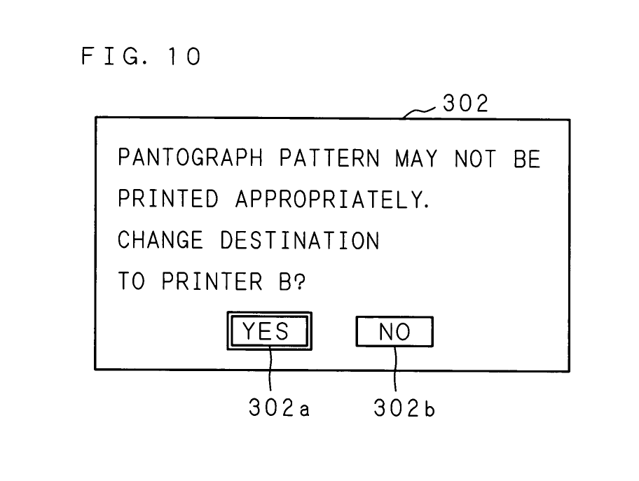

In step S24, if the controller 201 determines that it is impossible to reproduce the additional image(S24: NO), that is, if there is a possibility that the additional image may be printed in a condition incapable of exhibiting the effect of the pantograph pattern, then the controller 201 informs the user of this fact (step S26). FIG. 10 is a schematic view showing one example of a message screen to be displayed on the information processing apparatus 300 if a reproduction of an additional image is impossible. On a message screen 302 shown in FIG. 10, a message stating that there is a possibility that the pantograph pattern may not be printed appropriately is displayed, and select buttons 302a and 302b for asking whether or not the user wants to change the destination are provided. When the select button 302a is pressed, the destination is changed, whereas when the select button 302b is pressed, the print job is transmitted to the originally set destination. The result of a selection made on this message screen 302 is given to the print server 200.

The controller 201 of the print server 200 determines, based on the selection result given from the information processing apparatus 300, whether or not an instruction to change the destination is given (step S27). If the controller 201 determines that an instruction to change the destination is given (S27: YES), then it changes the destination and transmits the print job to the new destination (step S28). On the other hand, if the controller 201 determines that an instruction to change the destination is not given (S27: NO), then it transmits the print job to the originally set destination (S25).

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An image forming apparatus comprising
a controller capable of performing operations of:
receiving image data;
forming an image on a sheet based on the received image data;
storing image data to be composited with the received image data;
compositing the image data with the received image data;
forming an image based on the resulting composite image data; and
determining whether or not image formation is possible,
wherein the image formation based on the image data is executed or stopped according to a determined result.

2. The image forming apparatus according to claim 1, wherein said controller is further capable of performing an operation of detecting quality of an image to be formed on a sheet, and
wherein a determination as to whether image formation is possible or not is made based on a detected result.

3. The image forming apparatus according to claim 2, wherein said controller is further capable of performing an operation of measuring a density of an image, and
wherein the quality of the image is detected based on the measured density.

4. The image forming apparatus according to claim 2, wherein when the detected result shows degradation of the image quality, said controller is further capable of performing an operation of compensating for the degradation of the image quality.

5. The image forming apparatus according to claim 1, wherein said controller is further capable of performing an operation of predicting quality of an image to be formed on a sheet, and
wherein a determination as to whether image formation is possible or not is made based on a predicted result.

6. The image forming apparatus according to claim 5, wherein said controller is further capable of performing an operation of detecting a remaining amount of a consumable supply member used for image formation, and
wherein the quality of the image is predicted based on a detected result.

7. The image forming apparatus according to claim 5, wherein said controller is further capable of performing an operation of counting the number of times image formation was executed, and
wherein the quality of the image is predicted based on the counted number.

8. The image forming apparatus according to claim 5, wherein when the predicted result shows degradation of the image quality, said controller is further capable of performing an operation of compensating for the degradation of the image quality.

9. The image forming apparatus according to claim 1, wherein an image is formed on a sheet by electrophotographic processes.

10. The image forming apparatus according to claim 1, wherein when said controller determines that image formation based on the resulting composite image data is impossible, said controller is further capable of performing an operation of giving information stating a determined result.

11. The image forming apparatus according to claim 1, wherein the stored image data is image data for forming a pantograph pattern.

12. An image forming apparatus comprising:
means for receiving image data;
means for forming an image on a sheet based on the received image data;
storing means for storing image data to be composited with the received image data;
means for compositing the image data with the received image data;
image forming means for forming an image based on the resulting composite image data; and
determining means for determining whether or not image formation by said image forming means is possible,
wherein the image formation based on the image data is executed or stopped according to a determination result of the determining means.

13. The image forming apparatus according to claim 12, further comprising detecting means for detecting quality of an image to be formed on a sheet,
wherein the determining means determines, based on a detection result of the detecting means, whether or not image formation is possible.

14. The image forming apparatus according to claim 12, further comprising predicting means for predicting quality of an image to be formed on a sheet,
wherein the determining means determines, based on a prediction result of the predicting means, whether or not image formation is possible.

15. The image forming apparatus according to claim 12, wherein an image is formed on a sheet by electrophotographic processes.

16. The image forming apparatus according to claim 12, further comprising means for giving information stating a determination result when the determining means determines that image formation based on the composite image data is impossible.

17. The image forming apparatus according to claim 12, wherein the image data stored in the storing means is image data for forming a pantograph pattern.

18. An image forming system comprising:
an image forming apparatus; and
an image transmitting apparatus,
wherein said image forming apparatus comprises
a receiving section for receiving image data transmitted from said image transmitting apparatus,
a controller capable of performing operations of:
forming an image on a sheet based on the received image data;
storing image data to be composited with the received image data;
compositing the image data with the received image data;
forming an image based on the resulting composite image data; and
determining whether or not image formation is possible; and
a transmitting section for transmitting information regarding a determined result to said image transmitting apparatus, and
said image transmitting apparatus comprises:
a transmitting section for transmitting image data;
a receiving section for receiving the information transmitted from said image forming apparatus; and
a controller capable of performing an operarion of controlling whether the transmission of image data should be executed or stopped, based on the received information.

19. The image forming system according to claim 18, wherein when the transmission of image data is stopped, said controller in said image transmitting apparatus is further capable of performing an operation of giving information stating that the transmission of image data is stopped.

20. The image forming system according to claim 18, wherein said image forming system comprises a plurality of said image forming apparatuses, and said controller in said image transmitting apparatus is further capable of performing an operation of selecting a destination to send image data, based on information transmitted from each image forming apparatus.
